(19) United States
(12) Patent Application Publication
(10) Pub. No.: US 2023/0364561 A1
(43) Pub. Date: Nov. 16, 2023

(54) DIMETHYLMERCURY PERMEATION DEVICE AND FORMATION METHOD AND USE THEREOF

(71) Applicant: BATTELLE SAVANNAH RIVER ALLIANCE, LLC, AIKEN, SC (US)

(72) Inventors: BRIAN B. LOONEY, AIKEN, SC (US); THOMAS L. WHITE, EVANS, GA (US)

(21) Appl. No.: 17/741,825

(22) Filed: May 11, 2022

(51) Int. Cl. B01D 63/06; B01L 3/00; G01N 30/72; G01N 30/86

(52) U.S. Cl. CPC B01D 63/06; B01L 3/502761; G01N 30/7206; G01N 30/8665; B01L 2300/069; B01D 2313/04

(57) ABSTRACT

Dimethylmercury permeation devices are described, as well as methods of forming the devices and methods of utilizing the devices, e.g., in calibration of an analysis device. The permeation devices are loaded with methylmercury and formic acid that react to form pure phase dimethylmercury in a supersaturated solution. The dimethylmercury will equilibrate at an equilibrium vapor pressure in the headspace and diffuse at a temperature controllable rate out of the permeation device for use.

### FEDERAL RESEARCH STATEMENT

This invention was made with Government support under Contract No. DE-AC09-08SR22470, awarded by the U.S. Department of Energy. The Government has certain rights in the invention.

### BACKGROUND

Mercury (Hg) is a known and persistent environmental pollutant that is bioaccumulative and toxic in even small amounts. There are many stable Hg species, with each species exhibiting different characteristics including toxicity, solubility, mobility and bioavailability. Organic Hg, methylmercury ([CH₃Hg]⁺; MeHg), and dimethylmercury ((CH₃)₂Hg; diMeHg) are all highly toxic Hg species affecting human and animal health. diMeHg is of particular concern, as it is one of the most potent known neurotoxins that is also highly volatile, reactive, and flammable. As a result of the high toxicity, industrial and research uses of diMeHg have been curtailed, and it is no longer commercially produced or distributed. However, the various mercury species including diMeHg can be found naturally in the environment, as well as a result of anthropogenic activities such as mining, Hg manufacture and disposal, and fossil fuel combustion.

Hg contamination has become a global concern as it is often released into the atmosphere in one location with impact on ecosystems in another location, which can be thousands of kilometers away. Due to both the toxicity as well as the biomagnification in the food chain, monitoring both total Hg and Hg species is of high importance to assess potential impacts on human and animal health as well as the environment; additionally, understanding spatial and seasonal variability and lability of Hg species in the environment is important to refine the technically based assessment of risks. As such, analytical devices that can accurately detect, quantify, and differentiate Hg and key Hg species from one another are required. Further, analytical standards for key Hg species are needed to support analyses.

Permeation devices such as permeation tubes are well known devices that can provide a stable concentration of trace chemicals at high accuracy as analytical gas standards necessary for various analytical uses, e.g., set up and calibration of gas analyzer systems, hazardous gas alarm systems, or the like. Previously, diMeHg permeation tubes were prepared by enclosing a pure diMeHg compound within the sealed tube to provide a headspace concentration of diMeHg at vapor pressure with the liquid content resulting in a constant rate of diffusion of the gas at a fixed temperature. Unfortunately, as diMeHg is no longer industrially produced or distributed, diMeHg permeation tubes are likewise no longer being produced and as a result, accurate analytical examination of diMeHg is becoming increasingly difficult and expensive.

What are needed in the art are diMeHg analytical devices, and in particular permeation devices, that can provide a highly accurate and stable concentration of diMeHg for analytical purposes, but that do not require industrially produced diMeHg to form the device, i.e., that can synthesize the diMeHg in situ from reagents loaded within the device.

### SUMMARY

According to one embodiment, disclosed is a permeation device that includes a container, a liquid retained within the container, and a headspace over the liquid and within the container. The liquid includes formic acid and MeHg, and the headspace over the liquid includes diMeHg. The container includes a wall that is permeable to diMeHg in the vapor phase.

Also disclosed are methods for forming the permeation tubes. A method can include introducing formic acid and MeHg into a permeation tube, and then sealing the permeation tube following the introduction. The formic acid and the MeHg can be added to the permeation tube in a 1:1 molar ratio. Upon combination, the formic acid and the MeHg can react (e.g., at room temperature) to form diMeHg that can volatize into the headspace of the permeation tube.

Methods for utilization of the permeation tubes are also described. For instance, a method can include flowing a carrier gas at a known flow rate past the permeation tube held at a known temperature. The permeation tube includes formic acid and MeHg reactants in the liquid component of the permeation tube and includes the reaction product of diMeHg in the headspace. Upon flowing the carrier gas past the permeation tube, the carrier gas can mix with diMeHg as it diffuses through the wall of the permeation tube at a constant and known diffusion rate. The resulting gas flow, which includes the diMeHg at a known concentration, can then be sent to an analysis device, e.g., a gas chromatograph, a mass spectrometer, etc., e.g., for calibration or other testing of the analysis device.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates a permeation tube as disclosed herein.

FIG. 2 illustrates an exemplary calibration system and method incorporating a permeation tube as disclosed.

FIG. 3 presents a chromatogram of a reaction sample showing the presence of diMeHg near 2.9 min.

FIG. 4 presents a chromatogram selecting for 217 m/z ion in the reaction sample of FIG. 3.

FIG. 5 illustrates the match of an NIST Library Mass Spectrum of diMeHg to the compound of the chromatograph of FIG. 4.

FIG. 6 presents a chromatograph of another reaction sample showing the presence of diMeHg near 2.9 min.

FIG. 7 presents a chromatogram selecting for 217 m/z ion in the reaction sample of FIG. 6.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

In general, the present disclosure is directed to diMeHg permeation devices, methods for forming the devices, and methods for using the devices. The disclosed devices and methods are predicated on the discovery that diMeHg can be formed via a room temperature reaction that can generate a large amount of diMeHg in aqueous solution from readily available reagents. Through incorporation of the reagents in aqueous solution within a sealed permeation device, diMeHg can be synthesized in situ generating a supersaturated solution containing pure phase diMeHg. A headspace in the permeation device will carry the diMeHg at vapor pressure concentration, so as to provide a constant rate of diffusion of the diMeHg through the device wall(s) at a fixed temperature. The resulting performance of the permeation devices can be equivalent to previously known diMeHg permeation devices that required pure diMeHg for the liquid fill of the device.

The reagents to be included in the permeation device for the in situ diMeHg formation can include formic acid and MeHg, which are beneficially less toxic and more readily available than diMeHg. Without wishing to be bound to any particular theory, and as discussed further in the Examples section herein, the mechanism for the diMeHg reaction scheme is believed to be as follows:

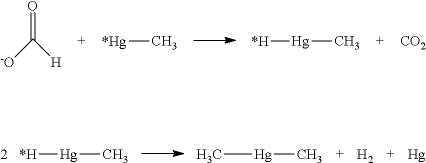

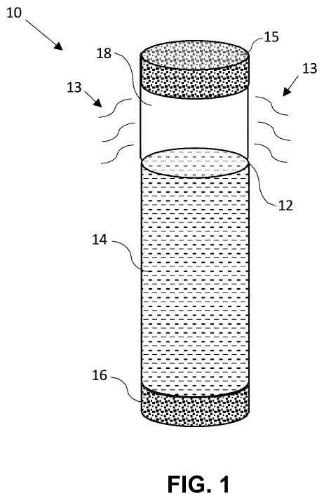

FIG. 1 presents one embodiment of a permeation device 10 that includes a small container 12, generally in the form of a tube, in which the reactants can be loaded in a liquid phase leaving a headspace 18 over the liquid 14. Upon formation, the tube is tightly closed on both ends with seals 15, 16. Following formation, the permeation device 10 includes the reaction mixture liquid 14 contents, and in particular, the diMeHg reaction product, in a two-phase equilibrium between its liquid phase in the liquid mixture 14 and its gas phase in the headspace.

To allow diffusion of the diMeHg from the tube 13, the container 12 includes a material that is permeable to the diMeHg product at vapor pressure in the headspace 18. The vapor pressure of diMeHg and absolute permeability of the material can be a direct function of the temperature of the system during use, which in general is that the higher the temperature, the higher the rate of permeation.

A material of a wall of a container 12 that is permeable to diMeHg in the gas phase can include materials generally known for use in formation of permeation devices, and in one embodiment, can include materials utilized in previously known diMeHg permeation tubes that were loaded with pure diMeHg in the liquid phase. By way of example, and without limitation, a wall of a permeation device 10 can include a polymeric material including silicone-based polymers, polytetrafluoroethylene (PTFE), polyethylene, polypropylene, polyvinyl acetate (PVA), polyamide, polyester, polyethylene terephthalate (PET), polyamide (nylon), perfluoroalkoxy copolymers (PFA), fluorinated ethene or any combination thereof.

In some embodiments, the permeable wall of the container 12 can include an inner surface that is modified with fluorine, e.g., hydrogen atoms of a polymer of the permeable wall can be substituted with fluorine atoms. In such an embodiment, some or all of the hydrogen atoms present on the inner surface of a permeable wall of a container can be substituted with fluorine atoms. For instance, fluorine substitution can be present in the wall in a gradient form in which the degree of substitution decreases from the inner surface to the outer surface of the wall.

The seals 15, 16 at either end of the permeation device 10 are not particularly limited with regard to materials, and any material commonly used in permeation devices is encompassed herein. For example, seals 15, 16 can be formed of a polymeric material such as silicone-based polymers, PTFE, polyvinyl chloride (PVC), PET, etc., as well as inorganic materials such as stainless steel, copper, brass, and glass. The seals can be applied by use of an adhesive, thermal welding, etc., optionally in combination with a secondary connector or the like.

To form a permeation device 10, an aqueous solution including the formate and MeHg reactants can be placed in the container 12 prior to sealing. As indicated in the reaction mechanism above, the reactants can be provided to the device 10 in about a 1:1 molar ratio (e.g., ±10% of a 1:1 molar ratio). The particular concentration of the reactants is not particularly limited, for instance, the reactants can be included in the aqueous mixture at a concentration of from about 0.2M to about 2M, such as about 1M in some embodiments. Beneficially, the reaction can occur at room temperature with the reaction mixture near neutral pH, e.g., from about pH 5.5 to about pH 6.5. As such, in some embodiments, a base can be added to the reaction mixture to raise the reaction mixture pH within the device 10. For instance, a small amount of a hydroxide, e.g., sodium hydroxide can be included in the liquid mixture to control the pH of the liquid mixture. Due to the nature of the chemistry, the formation process can be carried out to ensure that the primary stage of diMeHg occurs after the device is sealed, e.g., through order of addition of the reactants, environmental conditions prior to sealing of the device, etc. As such, the potential of diMeHg exposure can be minimized.

As indicated in the reaction scheme above, the reaction can form elemental mercury in addition to the diMeHg. As such, in some embodiments, the permeation device 10 can also include a material, e.g., a sequestrant, that can prevent the elemental Hg from inclusion in the permeate that exits the permeation device 10. In one embodiment, such a sequestrant can be an elemental metal that can form an amalgam with the elemental Hg.

Almost all metals can form an amalgam with elemental Hg, with notable exceptions including iron, platinum, tungsten, and tantalum. As such, in one embodiment, a sequestrant included in a permeation device 10 can include one or more amalgam-forming elemental metals. However, some metals are more efficient at Hg amalgam formation than others. Accordingly, in some embodiments, it may be beneficial to incorporate such a metal. By way of example, in one embodiment, a sequestrant 31 can include elemental gold, silver, copper, zinc, tin, or combinations thereof, optionally in conjunction with one or more additional amalgam-forming materials, in the form of a high surface area powder so as to selectively retain elemental Hg formed via during the diMeHg formation reaction.

The amounts of reactants included in a permeation device 10 can be adjusted according to the relatively simple chemistry of the reaction to provide a targeted amount of diMeHg and expected lifetime of the permeation device. For instance, a device 10 formed to contain 1 mL of liquid including 1M MeHg solution combined in a 1:1 molar ratio with 1 M formic acid solution would contain approximately 100 mg of mercury. Assuming a 5% reaction conversion, this would provide approximately 5 mg total of diMeHg product. Given the volatility of diMeHg this would provide a capacity of approximately 1 mg of diMeHg for permeation before the contents approached solubility. Assuming an average permeation rate of 1 ng/min over the life of the permeation device, the lifetime of the permeation device in this particular example would be approximately two years. Of course, control of permeation rate, e.g., by temperature control, device formation materials, wall thickness and porosity, etc., as well as control of initial device content, etc. can be utilized to modify a device lifespan.

The permeation device can be utilized in any analytical chemistry application in which a continuous flow of diMeHg at known concentration can be useful. In one embodiment, a permeation device can be utilized to calibrate an analysis device, e.g., a continuous emissions analyzer, e.g., a plasma emissions spectrometer or the like as may be utilized for detection of mercury pollutants.

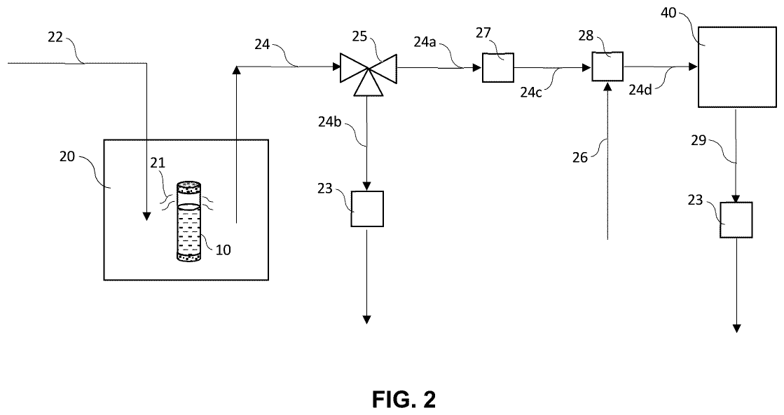

FIG. 2 schematically illustrates one embodiment of such a use. As illustrated, a system can include a chamber 20 that can retain the permeation device 10 and that is capable of being maintained at a constant temperature and pressure with high accuracy. For instance, the chamber 20 can be associated with a temperature and pressure control system capable of retaining the interior of the chamber 20 at a constant temperature within about 1° C. or less, such as about 0.5° C. or less, about 0.3° C. or less, or about 0.1° C. or less, in some embodiments. A constant temperature inside of the chamber 20 can establish a constant vapor pressure inside the permeation device 10, resulting in an equilibrium between the liquid and vapor phase of the diMeHg and constant rate diffusion of the diMeHg through the permeable wall of the permeation device 10.

The particular temperature of the chamber 20 during use can depend upon the desired parameters of the protocol. As stated above, the diMeHg vapor pressure increases as a function of temperature, and as such, the temperature of the chamber 20 can be utilized to control the diMeHg diffusion rate, and hence, the diMeHg concentration provided to the analysis device 40. By way of example, the chamber 20 can be held at a temperature of from about 25° C. to about 90° C., for instance, from about 35° C. to about 80° C. in some embodiments, so as to provide a diMeHg diffusion rate out of the permeation device 10 of from about 1 ng/min to about 100 ng/min, e.g., about 50 ng/min, in some embodiments.

The mercury permeation device 10 can have a known diMeHg diffusion rate at the controlled temperature of the chamber 20 and can be retained within the chamber 20 so as to entrain diffused diMeHg into a carrier flow 22. The carrier flow 22 can be air in some embodiments or can be an inert gas such as nitrogen, helium, argon, etc. The carrier flow 22 can be fed to the chamber 20 at a predetermined rate by use of a mass flow controller or other known system/device for controlling fluid flow. For instance, the carrier flow 22 can be provided from an air compressor or pressurized container of the desired carrier gas and can be provided to the chamber 20 at a flow rate of from, e.g., about 50 mL/min to about 500 mL/min, such as from about 100 mL/min to about 300 mL/min, in some embodiments. As the carrier flow 22 passes through the chamber 20, it will mix with diMeHg vapor 21 that diffuses out of the permeation device 10 to form a diMeHg flow 24 that contains diMeHg in a known volumetric concentration (generally in the parts per million or billion range).

The diMeHg flow 24 can pass from the chamber 20 as shown. In some embodiments, a system can include a 3-way valve 25 through which the diMeHg flow 24 can pass. During use of the system, the valve 25 can direct the diMeHg flow 24a toward the analysis device 40. During times of disuse, the valve 25 can be set to direct the diMeHg flow 24b into a trap 23. The trap can include one or more sequestrants that can remove any mercury species from the flow 24b. For instance, the trap 23 can include one or more amalgamation agents, such as those discussed above, for sequestration of elemental Hg contained in the flow 24b.

In addition, or alternative, to an amalgamation agent, a trap 23 can include one or more other types of sequestration agents that can capture diMeHg of the flow 24b. For instance, the trap 23 can include an activated carbon or an activated hydrogel that can capture multiple Hg species. A trap 23 can retain diMeHg (and elemental Hg as required) by any useful retention chemistry including, without limitation, covalent or noncovalent bond formation, e.g., charge/charge interaction, adsorption, absorption, etc. For example, Hg species retention in a capture module 22 can be obtained by incorporation of an ion-exchange resin as an active hydrogel in the trap 23. In one embodiment, a trap 23 can incorporate organic thiols and/or dithiocarbamates optionally in combination with Au⁺³ or other complexing agents such as acidic mixtures containing dithiol species. In one embodiment, a trap 23 can incorporate a thiol-functionalized resin hydrogel, e.g., a thiol-functionalized resin incorporated into a polyacrylamide or other suitable hydrogel. In one particular embodiment, a trap 23 can incorporate a 3 mercapto-propyl functionalized silica gel immobilized in a polyacrylamide gel.

During operation in conjunction with an analysis device 40, the diMeHg flow 24a that passes through the valve 25 can, in some embodiments, pass through a separator 27 which can remove elemental Hg reaction product from the flow 24a. For instance, a separator 27 can be utilized in conjunction with the inclusion of an Hg amalgamation agent in the permeation device 10 or alternative to such. A separator 27 can include an amalgamation agent as discussed above, which can selectively remove elemental Hg from the flow 24a without removing diMeHg from the outgoing flow 24c.

In some embodiments, a system can also include the capability of addition of a diluent 26 that can be combined with diMeHg flow 24c as a mixer 28 to achieve a desired final diMeHg concentration in the flow 24d provided to the analysis device 40. The diluent of choice can generally be the same material as used for the carrier flow 22, but this is not a requirement of a system. A diluent be provided to a mixer 28 at a constant known rate by use of a flow controller as known. The particular flow rate of a diluent 26 will vary to provide the desired final diMeHg concentration, e.g., from about 5 L/min to about 25 L/min, in some embodiments. Of course, a preferred flow rate for a diluent 26 will depend upon the particular equipment utilized as well as the particular parameters of the protocol. The total flow 24d provided to the analysis device 40 will be the combination of the diMeHg flow 24c and the flow of diluent 26. The resulting calibration gas mixture at the analysis device 40 will include a diMeHg concentration calculated by dividing the diMeHg output rate of the permeation device 10 by the total flow 24d.

During a calibration protocol, results displaying signal intensity of the analysis device 40 and diMeHg concentration of the flow 24d are used to plot a calibration scheme. A first signal intensity generated by the analysis device 40 in response to a first calibration diMeHg concentration can be used as initial data. Further, signal intensities generated by the analysis device 40 in response to other tested streams, e.g., a blank having zero diMeHg concentration in conjunction with one or more additional tested diMeHg concentrations in the input stream 24d can be used to develop a calibration curve according to standard practice, which can be a linear relationship between the signal intensity of the analysis device and the diMeHg concentration or a nonlinear relationship, i.e., any descriptive mathematical relationship between the analyzer signal intensity of the analysis device 40 and the diMeHg concentration of the feed stream 24d.

Following analysis, an output flow 29 from the analysis device 40 can be fed through a trap 23, as described above, to capture remaining diMeHg in the flow 29.

The present invention may be better understood with reference to the examples, set forth below.

### Example

A contained microcosm containing 0.5 M methylmercury and 0.5 M formate was formed. Mercury concentration in the vapor phase and headspace were significantly higher than expected at 22° C. During the initial gas subsampling of this system, the microcolumn trap collected approximately 1000× the expected mass of mercury (>>1000 ng). In further runs, the microcosm headspace gas was collected and diluted in clean air (DF 10). Two microliters of the diluted gas were applied to an adsoQUICK trap to collect the mercury for analysis. The resulting samples confirmed that the headspace in the microcosms contained high levels of mercury-containing compounds. The results for duplicate microcosms were 1,625,000 ng/mL and 1,684,000 ng/mL of mercury, which equates to gases containing mercury comprising 16% and 16.6% by volume in the microcosm headspace. These concentrations were considered estimates since the amount of mercury on the traps was still higher than the 300-ng upper calibration standard of the system. Importantly, the measured headspace concentrations were several orders of magnitude above expected values bases on Henry's Law partitioning between a solution and a gas phase and significantly above the vapor pressure of elemental mercury.

The results indicated a chemical reaction occurring between formate and methylmercury, resulting in the generation of a more volatile mercury compound. With the addition of a second covalently bound methyl group, dimethylmercury is comparably a more volatile mercury species with a documented vapor pressure (approximately 8% by volume) that is similar to the estimated/measured values in the headspace. In designing further experiments, abiotic formation of diMeHg in aqueous solution was considered unlikely since it has not been documented in the literature to occur in any significant extent with these or similar reagents.

Follow-up actions were taken to determine the nature/form of the mercury in the headspace gas, including:
a) a scoping nuclear magnetic resonance (NMR) measurement that suggested a rapid and relatively complete conversion of CH₃Hg⁺ to covalently bonded synthesis products; and
b) a subsequent gas chromatography-mass spectroscopy (GC-MS) study that provided definitive identification of (CH₃)₂Hg as a principal end product of the synthesis reaction(s).

The scoping study using NMR was performed by mixing a trace quantity of 1 M CH₃HgOH and 1 M formic acid in an NMR tube and then scanning changes in mercury and carbon bonding in the liquid phase at various times. Scoping results confirmed formation of covalent C—Hg bonds at early times. The scoping NMR also indicated that the synthesis reaction was rapid and relatively complete since the signal in solution dissipated within about five minutes in a purged NMR tube as the products partitioned out of solution into the vapor phase and were vented into the chemical hood. The follow-on GC-MS study provided definitive identification of (CH₃)₂Hg and confirmed the existence of a high-yield aqueous synthesis reaction.

Samples were prepared for GC-MS analysis as follows: A clean-standard 40 mL screw top septum vial was loaded with 15 mL of Hg-free DI water and capped. One milliliter of gas was withdrawn from the vial using a gas tight syringe to generate slightly underpressurized condition to minimize the potential for loss of analyte. A measured volume of headspace gas from a contained microcosm containing 0.5 M methylmercury and 0.5M formate was added to the vial. Vials were prepared at two different spike levels: 3 μL and 30 μL of headspace gas. These spike quantities were selected to provide the appropriate signal on the GC-MS based on past analysis of (CH₃)₂Hg.

The sealed glass vial was kept cold at approximately 4° C. prior to placement into the autosampler tray of a purge and trap GC-MS. The sample was purged with helium for 11 minutes at a flow rate of 40 mL/minute. During purge, 20 μL of a deuterated volatile organic internal standard mixture (2000 mg/L) was automatically added by the instrument. The purged gas was passed through a 24 cm column containing Tenax® at 20° C. to trap organic and organomercury compounds. Following the purge, the Tenax® trap was desorbed for 2 minutes at 180° C. and any desorbed compounds were passed via heated transfer line to the GC-MS. The GC was operated in split injection mode at a ratio of 1:100. The organic compounds were separated on a DB-5 GC column (30 m×0.25 mm ID×1 μm film thickness). The GC oven was programmed to hold at 35° C. for 1 minute and increase at a rate of 20° C./minute to a final temperature of 180° C., where it was held for 5 minutes. The mass spectrometer was operated in scanning mode over a range of 30 m/z to 450 m/z.

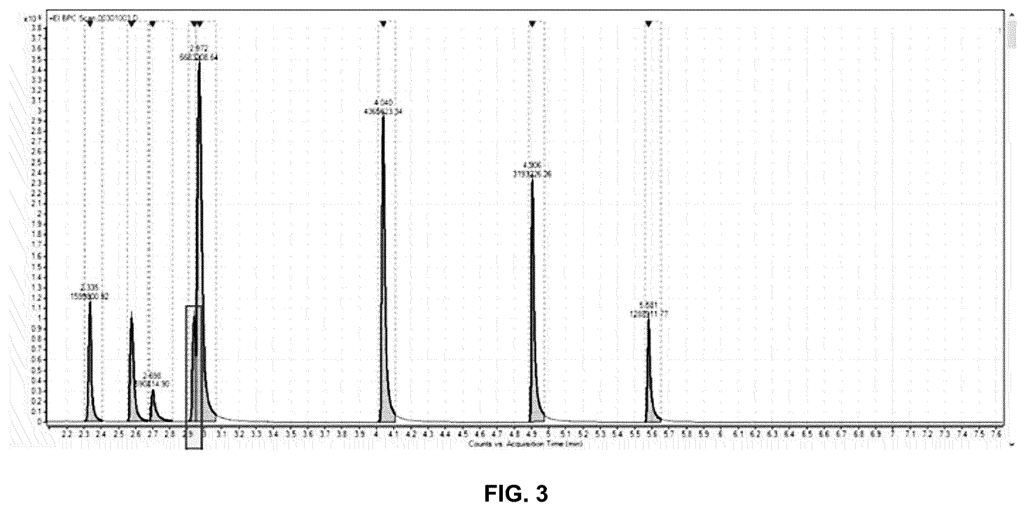

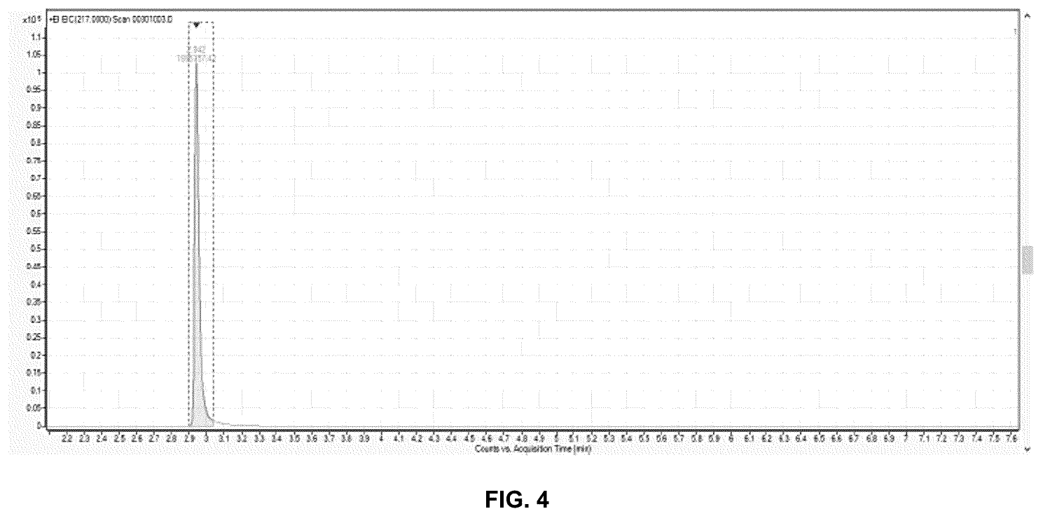

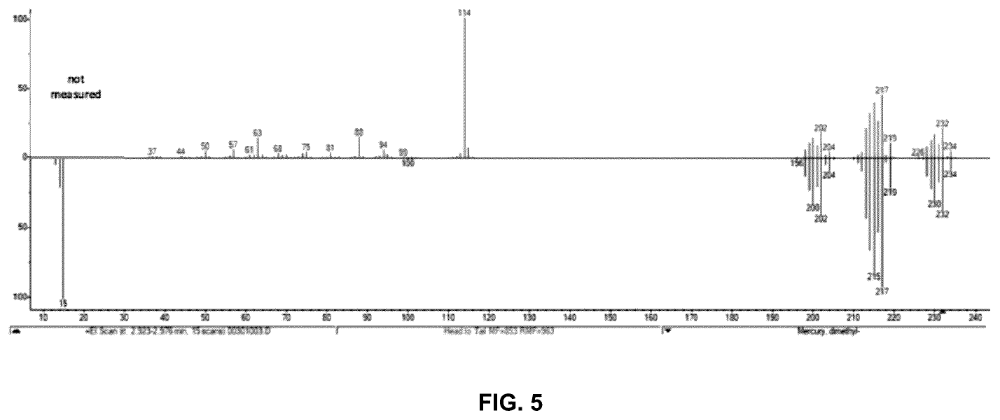

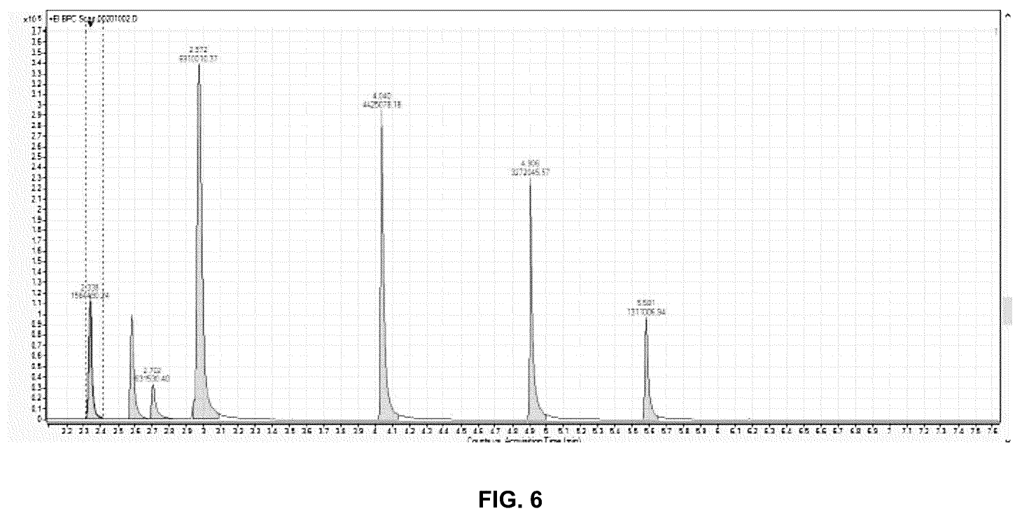

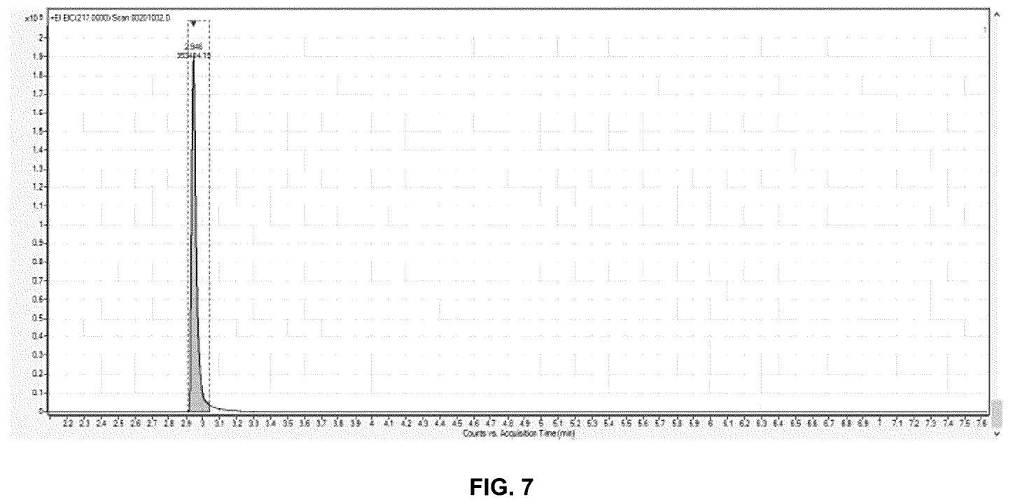

Two samples were analyzed by purge and trap GC-MS: “30 DMM” (containing 30 μL of headspace gas) and “3 DMM” (containing 3 μL of headspace gas). (CH₃)₂Hg was detected in both samples. FIG. 3 shows the full chromatogram associated with “30 DMM”, showing the six spiked internal standards. (CH₃)₂Hg can be seen as a small shoulder peak preceding the internal standard peak at 2.9 minutes. FIG. 4 shows the chromatogram when selecting only for the 217 m/z ion. That ion is the highest intensity mercury fragment in the NIST library mass spectrum for (CH₃)₂Hg, which corresponds to the mass following ionization and loss of one methyl group. FIG. 5 demonstrates the NIST library match of dimethylmercury to the reaction product of formate and methylmercury. FIG. 6 and FIG. 7 show the full chromatogram and isolated ion chromatogram at 217 m/z for the sample labeled “3 DMM”.

When comparing with the closest internal standard peak (1,3-diflurobenzene), assuming the same relationships between signal and mass, the (CH₃)₂Hg was quantified at 1.38 μg in the sample labeled “30_DMM” and 0.266 μg in “3_DMM.” This equates to headspace concentrations of 46,000 ng/mL and 88,700 ng/mL, which are about 30 times lower than measurement results using direct mercury analysis. Given the uncertainties in estimation, the sample handling/transport and storage of the GC-MS samples, and the likelihood that the GC-MS signal response for (CH₃)₂Hg may differ from 1,3-diflurobenzene, these results were considered to be reasonably similar for purposes of the scoping evaluation.

Based on this finding, the scientific literature was evaluated to develop a conjectural reaction mechanism. The most likely mechanisms involved formation of an intermediate methylmercury hydride. Formate has also been used as a reagent for generating hydrides, suggesting the possibility of the suggested reaction mechanism includes two steps: 1) reaction of formate with CH₃Hg+ to from a relatively volatile and labile methylmercury hydride, and 2) a disproportionation reaction involving two methylmercury hydride molecules to form (CH₃)₂Hg and Hg0·per the reaction mechanism:

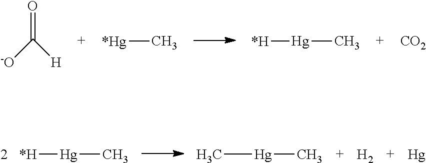

These reactions would be expected to occur over a finite timeframe (hours) and would eventually result in the conversion of the starting CH₃Hg+ to the disproportionation products. The observations in the formate microcosms suggest reaction rates that are significantly faster (minutes).

The data confirmed that the microcosms with formate resulted in chemical conversion of the reactants into dimethylmercury with very high (volume % level) concentrations of mercury in the headspace. This behavior was contrasted with similar microcosms but for the presence of glycolate rather than formate. While higher measured concentration in the headspace gas in the glycolate microcosm could be influenced by the formation of a trace amount of dimethyl mercury or a similar product, the amount of mercury in the headspace of the glycolate microcosms was about 1,000×lower than the formate microcosms. Based on these data, the amount of dimethylmercury formed with glycolate (if any) was significantly less than that formed with formate.

While certain embodiments of the disclosed subject matter have been described using specific terms, such description is for illustrative purposes only, and it is to be understood that changes and variations may be made without departing from the spirit or scope of the subject matter.

What is claimed is:

1. A permeation device comprising:
a sealed container, the sealed container including a wall that is permeable to dimethylmercury in the vapor phase;
a liquid retained within the container, the liquid comprising formic acid and methylmercury;
a headspace over the liquid and within the container.

2. The permeation device of claim 1, wherein the liquid comprises formic acid and methylmercury in about a 1:1 molar ratio.

3. The permeation device of claim 1, wherein the container is in the shape of a tube.

4. The permeation device of claim 1, wherein the wall comprises a silicone-based polymer, a polytetrafluoroethylene, a polyethylene, a polypropylene, a polyvinyl acetate, a polyamide, a polyester, a polyethylene terephthalate, a polyamide, a perfluoroalkoxy copolymer, a fluorinated ethene or any combination thereof.

5. The permeation device of claim 1, further comprising one or more seals, the one or more seals independently comprising a silicone-based polymer, a polytetrafluoroethylene, a polyvinyl chloride, a polyethylene terephthalate, stainless steel, copper, brass, glass, or any combination thereof.

6. The permeation device of claim 1, wherein the liquid is at a pH of from about 5.5 to about 6.5.

7. The permeation device of claim 6, the liquid further comprising a base.

8. The permeation device of claim 1, the permeation device further comprising an elemental mercury amalgamation agent.

9. The permeation device of claim 8, the elemental mercury amalgamation agent comprising gold, silver, copper, zinc, tin, or any combination thereof.

10. A method for forming a dimethylmercury permeation device, the method comprising:
locating an aqueous solution within a permeation device, the aqueous solution comprising a formic acid and a methylmercury; and
sealing the permeation device, the permeation device comprising a wall that is permeable to dimethylmercury in the vapor phase.

11. The method of claim 10, wherein the aqueous solution comprises the formic acid and the methylmercury in about a 1:1 molar ratio.

12. The method of claim 10, further comprising adjusting a pH of the aqueous solution to a value of from about 5.5 to about 6.5.

13. The method of claim 10, wherein at room temperature and pressure, the formic acid and the methylmercury react within the sealed permeation device to form dimethylmercury according to the reaction scheme:

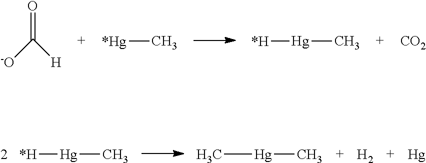

14. A method for calibration of an analysis device, the method comprising:
locating a permeation device in a chamber, the chamber being configured to be maintained at a constant temperature and pressure, the permeation device comprising a sealed container that includes a wall that is permeable to dimethylmercury in the vapor phase, a liquid retained within the container that includes formic acid and methylmercury, and a headspace over the liquid, wherein the formic acid and the methylmercury react to form dimethylmercury, a portion of the dimethylmercury diffusing through the wall;
passing a carrier gas flow through the chamber, the carrier gas flow mixing with the diffused dimethylmercury to form a dimethylmercury flow; and
delivering the dimethylmercury flow to an analysis device.

15. The method of claim 14, further comprising removing elemental mercury from the dimethylmercury flow.

16. The method of claim 14, further comprising adding a diluent to the dimethylmercury flow to modify a dimethylmercury concentration within the dimethylmercury flow delivered to the analysis device.

17. The method of claim 14, further comprising repeating the process with one or more different dimethylmercury flows, the different dimethylmercury flows including different concentrations of dimethylmercury, the method further comprising forming a dimethylmercury calibration curve for the analysis device.

18. The method of claim 14, further comprising passing the dimethylmercury flow through a mercury trap following exit of the dimethylmercury flow from the analysis device.
